(19) United States
(12) Patent Application Publication
(10) Pub. No.: US 2007/0085873 A1
(43) Pub. Date: Apr. 19, 2007

(54) INK-JET IMAGE FORMING APPARATUS TO ADJUST A DISTANCE BETWEEN A PLATEN AND AN INK-JET HEAD

(76) Inventor: Youn-gun Jung, Gunpo-si (KR)

Correspondence Address: STANZIONE & KIM, LLP, 919 18TH STREET, N.W., SUITE 440, WASHINGTON, DC, 20006, US

(21) Appl. No.: 11/466,874

(22) Filed: Aug. 24, 2006

(30) Foreign Application Priority Data
Oct. 13, 2005 (KR) 2005-96499

(51) Int. Cl. B41J 2/165

(52) U.S. Cl. 347/22

(57) ABSTRACT

An ink-jet image forming apparatus includes an ink-jet head including a nozzle unit having a length in a main scanning direction corresponding to a width of a printing medium, a platen to move to a printing location in which the platen faces the nozzle unit and supports a rear side of the printing medium, and to a maintenance location different from the printing location for a maintenance operation, a cam locus to guide the platen and having an interval adjusting portion disposed in a portion corresponding to the printing location of thereof to adjust an interval between the platen and the nozzle unit.

### CROSS-REFERENCE TO RELATED APPLICATIONS

This application claims priority under 35 U.S.C. §119(a) from Korean Patent Application No. 10-2005-0096499, filed on Oct. 13, 2005, in the Korean Intellectual Property Office, the disclosure of which is incorporated herein in its entirety by reference.

### BACKGROUND OF THE INVENTION

1. Field of the Invention

The present general inventive concept relates to an ink-jet image forming apparatus to adjust a distance between a platen and an ink-jet head, and more particularly, to an ink-jet image forming apparatus including an ink-jet head having a nozzle unit having a length in a main scanning direction corresponding to a width of a printing medium.

2. Description of the Related Art

In general, ink-jet image forming apparatuses are apparatuses for ejecting ink on a paper transferred to a sub-scanning direction using an ink-jet head (shuttle type ink-jet head) which is driven to reciprocate in a main scanning direction to form an image. Recently, an attempt has been made to implement high-speed printing by using the ink-jet head (the array ink-jet head) equipped with a nozzle unit having a length in the main scanning direction corresponding to a width of the paper, instead of the shuttle type ink-jet head. In the ink-jet image forming apparatus, the ink-jet head is fixed, and only the paper is transferred to the sub-scanning direction. Therefore, a drive unit of the ink-jet image forming apparatus is simple and implementation of high-speed printing is possible. In the ink-jet image forming apparatus, if a printing margin of a width direction of the paper is not considered, the length of the nozzle unit is about 210 mm to correspond to the paper of A4, for example.

In the ink-jet image forming apparatus, papers having various thicknesses can be used. If a thickness of the paper changes, an interval between the nozzle unit and an upper side of the paper are changed. The interval between the nozzle unit and the upper side of the paper has an effect on printing quality.

### SUMMARY OF THE INVENTION

The present general inventive concept provides an ink-jet image forming apparatus including an array ink-jet head to adjust an interval between a nozzle unit and an upper side of a printing medium.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an ink-jet image forming apparatus, including an ink-jet head including a nozzle unit having a length in a main scanning direction corresponding to a width of a printing medium, a platen to move to a printing location in which the platen faces the nozzle unit and supports a rear side of the paper and to a maintenance location different from the printing location for a maintenance operation, and a cam locus to guide the platen and having an interval adjusting portion disposed in a portion corresponding to the printing location thereof to adjust an interval between the platen and the nozzle unit.

The foregoing and/or other aspects of the present general inventive concept may also be achieved by providing An ink-jet image forming apparatus including an ink-jet head having a nozzle unit, and a platen disposed to form a paper conveying path with the nozzle unit, disposed in a printing location having a first printing location to have a first distance with the nozzle unit in the paper conveying path and a second printing location to have a second distance with the nozzle unit in the paper conveying path, and disposed a maintenance location different from the printing location where the ink-jet head is maintained.

The foregoing and/or other aspects of the present general inventive concept may also be achieved by providing An ink-jet image forming apparatus including an ink-jet head having a nozzle unit, and a platen disposed to form a paper conveying path with the nozzle unit, disposed in a printing location having a first printing location for a first printing medium and a second printing location for a second printing medium, and disposed a maintenance location different from the printing location where the ink-jet head is maintained.

The foregoing and/or other aspects of the present general inventive concept may also be achieved by providing A method of an ink-jet image forming apparatus, the method including disposing a platen to form a paper conveying path with the nozzle unit, disposing the platen in a printing location having a first printing location to have a first distance with the nozzle unit in the paper conveying path and a second printing location to have a second distance with the nozzle unit in the paper conveying path, and disposing the platen in a maintenance location different from the printing location where the ink-jet head is maintained.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an ink-jet image forming apparatus according to an embodiment of the present general inventive concept;

FIG. 2 is a view illustrating a nozzle unit of the image forming apparatus of FIG. 1;

FIG. 3 is a perspective view illustrating a platen of the image forming apparatus of FIG. 1;

FIG. 4 is a view illustrating a maintenance unit of the image forming apparatus of FIG. 1 according to an embodiment of the present general inventive concept;

FIG. 5 is an exploded perspective view illustrating the maintenance unit of FIG. 4;

FIG. 6A is a view illustrating a cam locus of the maintenance unit of FIGS. 4 and 5;

FIGS. 6B and 6C are views illustrating locations of a platen of the image forming apparatus of FIGS. 1, 4, and 5 when an image is printed on a plain paper and a photo paper, respectively;

FIG. 7 is a view illustrating a structure to drive a cap member using a driving motor in the maintenance unit of FIGS. 4 and 5;

FIG. 8 is a perspective view illustrating a swing gear and a driven gear of the structure of FIG. 7;

FIG. 9 is a view illustrating a wiping locus of the maintenance unit of FIG. 5;

FIG. 10 is a perspective view illustrating a wiper of the maintenance unit of FIGS. 4 and 5; and

FIGS. 11, 12, and 13 are views illustrating a movement of the platen, wiping, and capping operation, respectively.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

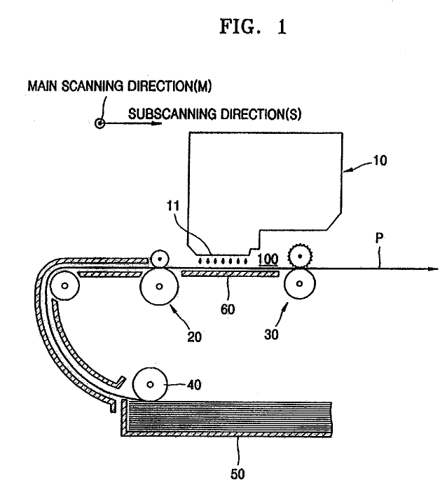

FIG. 1 is a view illustrating an ink-jet image forming apparatus according to an embodiment of the present general inventive concept. Referring to FIG. 1, a printing medium, such as a sheet of paper P picked up by a pickup roller 40 from a paper feeding cassette 50 is conveyed by a conveying unit 20 in a sub-scanning direction S. An ink-jet head 10 is installed in an upward direction of the paper P. The ink-jet head 10 prints an image on the paper P supported by a platen 60, which forms a paper conveying path 100 with the ink-jet head 10, by ejecting ink on the paper P in a fixed location. An exhaust unit 30 ejecting the printed paper P is installed at an outlet of the ink-jet head 10.

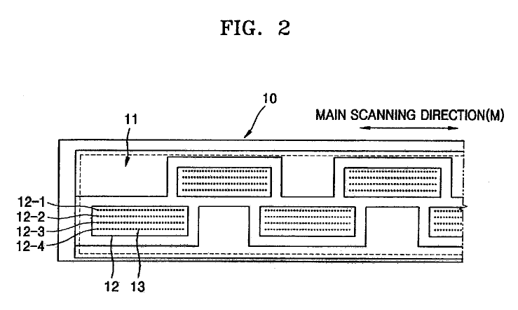

The ink-jet head 10 is an array ink-jet head equipped with a nozzle unit 11 having a length in a main scanning direction M corresponding to a width of the paper P. That is, the nozzle unit 11 can print the image having an image width same as the width of the paper P without reciprocating in the main scanning direction. FIG. 2 is a view illustrating the nozzle unit 11. Referring to FIGS. 1 and 2, the nozzle unit 11 includes a plurality of nozzle plates 12 arranged in a zig-zag pattern in the main scanning direction M. A plurality of nozzles 13 ejecting the ink is formed in each nozzle plate 12. A plurality of nozzle rows 12-1, 12-2, 12-3, and 12-4 can be arranged in the nozzle plate 12. And each nozzle row 12-1, 12-2, 12-3 or 12-4 can eject the ink of the same color or different color, for example, cyan, magenta, yellow, and black. Although FIG. 2 illustrates an example of the nozzle unit 11, the scope of the present general inventive concept is not limited to the nozzle unit 11 of FIG. 2. Although not shown, the ink-jet head 10 includes a chamber which communicates with each nozzle 13 and includes ejecting units (for example, a piezo element and a heater) disposed in the chamber for providing pressure for ejecting the ink, and a channel for supplying the ink to the chamber. The chamber, the ejecting units, and the channel are well-known and thus, a detailed description thereof will be omitted.

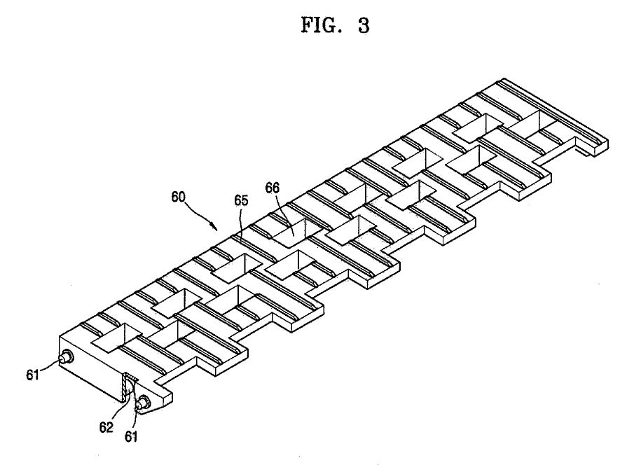

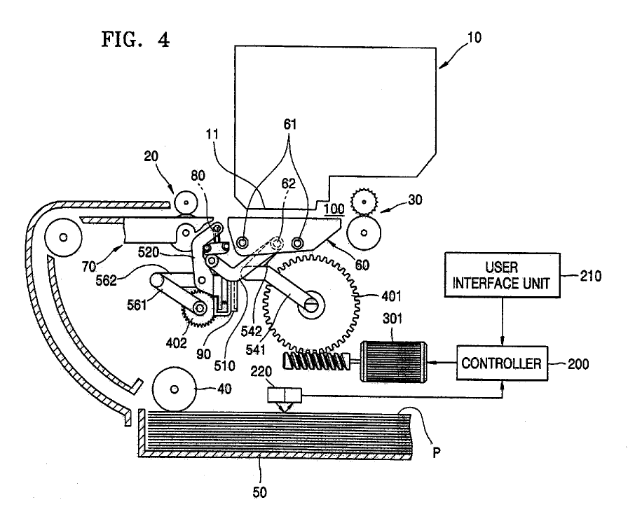

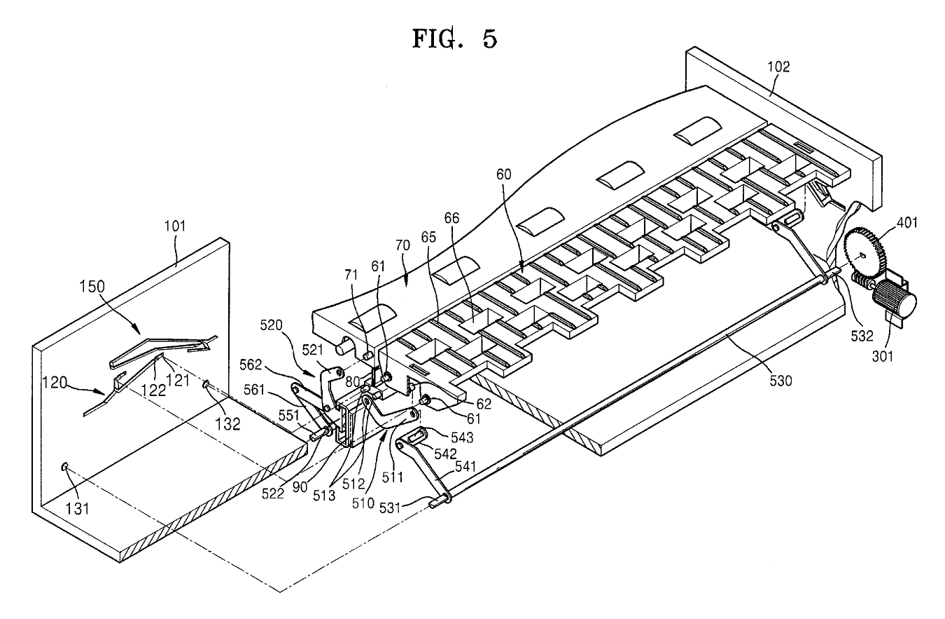

The platen 60 is disposed to face the nozzle unit 11. As illustrated in FIG. 3, a plurality of ribs 65 to support a rear side of the paper P is disposed in the platen 60. The platen 60 is disposed so that the nozzle unit 11 of the ink-jet head 10 can maintain a predetermined interval with the paper P, for example, an interval of 0.5-2 mm. A plurality of accommodating portions 66 are disposed in the platen 60 to correspond to the arrangement of the plurality of nozzle plates 12 illustrated in FIG. 2 in order to accommodate spitted ink. In order to implement good printing quality, the nozzle unit 11 has to be optimally maintained in a state to print. That is, the nozzle unit 11 should be ready to print without delay or interference. To this end, a maintenance operation including spitting, wiping, and capping is performed. When a printing operation has not been performed for a predetermined amount of time or a certain number of the nozzles 13 have not been used for a predetermined amount of time during the printing operation, the nozzles 13 and the ink around the nozzles 13 are dried so that viscosity of the ink is increased and an ejecting defect occurs. Spitting is ejecting the ink several times for a predetermined amount of time so as to remove the ink of which viscosity is increased. Wiping is removing solidified ink and/or foreign substances around the nozzles 13 by scrubbing a surface of the nozzle unit 11. Capping is covering and blocking the nozzle unit 11 from external air and preventing the nozzles 13 from being dried when the printing operation is not performed for a predetermined amount of time. Protrusions 61 and a guide pole 62 will be described later with reference to FIGS. 4 and 5.

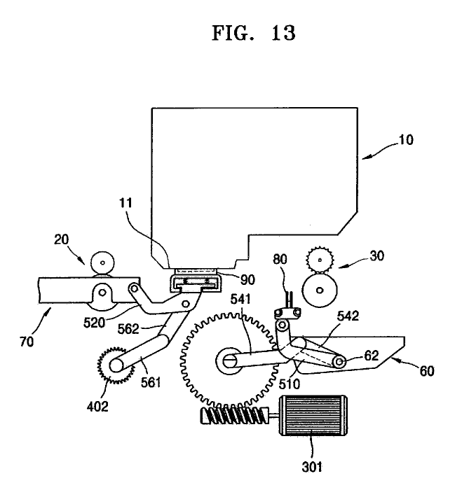

For the maintenance operation, the ink-jet image forming apparatus includes a cap member 90 to cap the nozzle unit 11, and a wiper 80 to wipe the nozzle unit 11. In the ink-jet image forming apparatus of the present embodiment, the platen 60 is moved to a printing location (see FIG. 4) in which the platen 60 faces the nozzle unit 11 and supports the rear side of the paper and a maintenance location (see FIG. 13) different from the printing location so that the wiper 80 and the cap member 90 can access to the nozzle unit 11. The maintenance location is moved from the printing location by a distance to provide a maintenance device with a space in which the maintenance device can perform the maintenance operation on the nozzle unit 11. That is, when the platen 60 moves away from the printing location in which the platen 60 forms the paper conveying path 100 with the nozzle unit 11, the maintenance device performs the maintenance operation on the nozzle unit 11.

Papers having various thicknesses can be used in the ink-jet image forming apparatus. A photo paper (having a thickness of about 0.3 mm) used when printing a photograph is thicker than a plain paper (having a thickness of about 0.1 mm) generally used when printing a document. Therefore, an interval between the nozzle unit 11 and the paper P becomes narrow if the photo paper is used. In order to implement good printing quality, an interval between the nozzle unit 11 and the upper side of the paper P have to be maintained at a predetermined interval. To this end, a plane or structure to move the ink-jet head 10 or the platen 60 can be used in the ink-jet forming apparatus. Since the array ink-jet head 10 is very large compared to a shuttle type ink-jet head, it may be easier to move the platen 60. The ink-jet image forming apparatus is characterized in that an interval between the upper side of the paper P and the nozzle unit 11 is adjusted by moving the platen 60 from the printing location to the maintenance location, so that the maintenance device performs the maintenance operation which the platen 60 moves away from the printing location. And then, since a separate driving unit to adjust the interval between the upper side of the paper and the nozzle unit 11 is unnecessary, the structure of the ink-jet image forming apparatus is simple and components and manufacturing costs can be reduced.

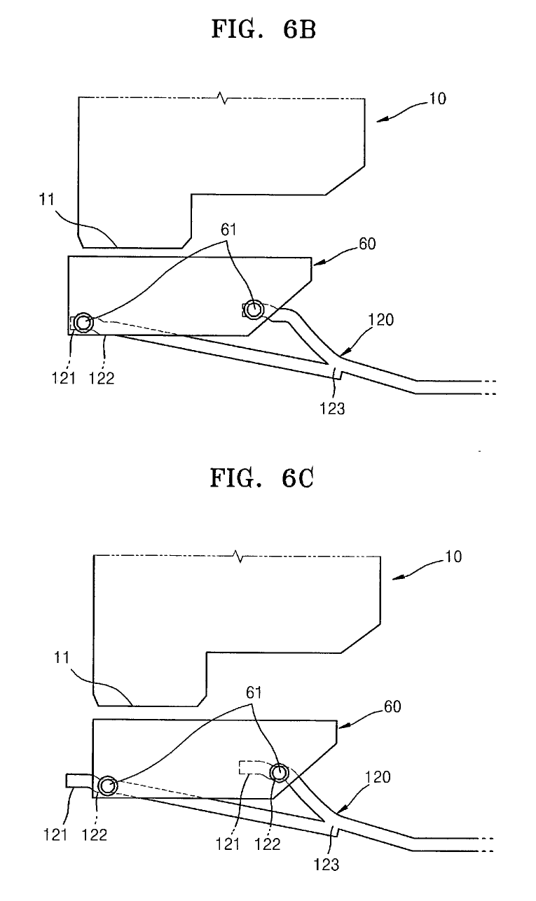

Referring to FIGS. 1, 4, and 5, the ink-jet image forming apparatus may drive the platen 60 and the wiper 80 using a maintenance motor 301 and may drive the cap member 90 using another driving source. The cap member 90 is driven with respect to a guide member 70, which guides the paper P to the paper conveying path 100 formed between the nozzle unit 11 and the platen 60, using a driving motor 302 (FIG. 7) driving the conveying unit 20 and the exhaust unit 30. In this case, the pickup roller 40 picking up the paper P from the paper feeding cassette 50 can be driven using another driving source. When the pickup roller 40 is driven by the driving motor 302, a clutching unit (not shown) for selectively transferring a driving force of the driving motor 302 to the pickup roller 40 may be provided. The clutching unit is well-known, and thus, a detailed description thereof will be omitted.

Referring to FIG. 5, a cam locus 120 is disposed on side walls 101 and 102. The protrusion 61 is formed in both sides of the platen 60. The protrusion 61 is inserted in the cam locus 120. The platen 60 is moved to the printing location and the maintenance location along the cam locus 120.

A shaft 530 is inserted into a hole 131 to be supported to be rotated in the side walls 101 and 102. D-cut parts 531 and 532 are disposed on both ends of the shaft 530. “D-cut parts” indicates that a portion of a circular shape is cut off to form the D-cut part. A first connection arm 541 is combined with the d-cut part 531 of the shaft 530 and connected to a second connection arm 542 to be pivoted. A first driven gear 401 is combined with the d-cut part 531. A slot 543 is formed in the form of a long hole in the connection arm 542. The guide pole 62 disposed in the platen 60 is inserted into the slot 543. A length of the long hole of the slot 543 corresponds to a period of time during which the guide pole 62 moves along the slot 543 while the platen 60 moves according to a rotation of the first and second connecting arms 541 and 542. That is, the wiper 80 moves a period of time after the platen 60 starts moving to the maintenance location. The maintenance motor 301 rotates the first driven gear 401 and moves the platen 60 to the printing location and the maintenance location. When the maintenance motor 301 rotates to move the first connection arm 541 with respect to the shaft 530 to control the platen 60 to move from the printing location to the maintenance location through a coupling of the second connecting arm 542 and the guide pole 62. Since the protrusion 61 of the platen 60 is inserted into the cam locus 120, the platen 60 moves in a direction corresponding to a shape of the cam locus 120.

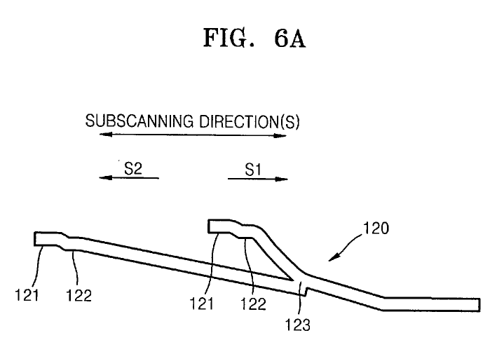

FIG. 6A illustrates an example of an interval adjusting portion which increase or decreases an interval between the platen 50 and the nozzle unit 11 as the platen 60 moves in the sub-scanning direction S. Referring to FIG. 6A, step parts 121 and 122 are disposed in a portion corresponding to the printing location of the cam locus 120. The step parts 121 and 122 are separated from each other in the sub-scanning direction S and stepped perpendicularly to the sub-scanning direction S. The step part 121 corresponds to a first printing location of the platen 60, and the step part 122 corresponds to a second printing location of the platen 60. The step parts 121 and 122 are spaced-apart from each other and disposed parallel to each other so that the platen 60 is disposed parallel to the nozzle unit 11 to form the paper conveying path 100. The step parts 121 and 122 form the printing location of the platen 60 and are connected to each other through a connection part disposed between the step parts 121 and 122. The connection part is inclined between the step part 121 and the step part 122. The cam locus 120 further includes an inclined part 123 extended from the step parts 121 and 122 to control the platen 60 to move between the printing location and the maintenance location as illustrated in FIGS. 6B and 6C. If the platen 60 is moved in a direction S1, the interval between the platen 60 and the nozzle unit 11 increases, and if the platen 60 is moved in a direction S2, the interval between the platen 60 and the nozzle unit 11 decreases. The platen 60 is moved in the direction S1 or S2 using the maintenance motor 301 with the above structure so that the interval between the platen 60 and the nozzle unit 11 can be adjusted. The number of step parts is not restricted to two, and if necessary, a plurality of step parts may be disposed to adjust a distance between the platen 60 and the nozzle unit 11 to maintain the interval between the upper surface of the paper P and the nozzle unit 11 to be constant or uniform regardless a thickness of the paper P.

The step part 121 corresponds to a first printing location of the platen 60, and the step part 122 corresponds to a second printing location of the platen 60. The step parts 121 and 122 are spaced-apart from each other and disposed parallel to each other so that the platen 60 is disposed parallel to the nozzle unit 11 to form the paper conveying path 100. The step parts 121 and 122 form the printing location of the platen 60 and are connected to each other through a connection part disposed between the step parts 121 and 122. The connection part is inclined between the step part 121 and the step part 122. The cam locus 120 further includes an inclined part 123 extended from the step parts 121 and 122 to control the platen 60 to move between the printing location and the maintenance location as illustrated in FIGS. 6B and 6C.

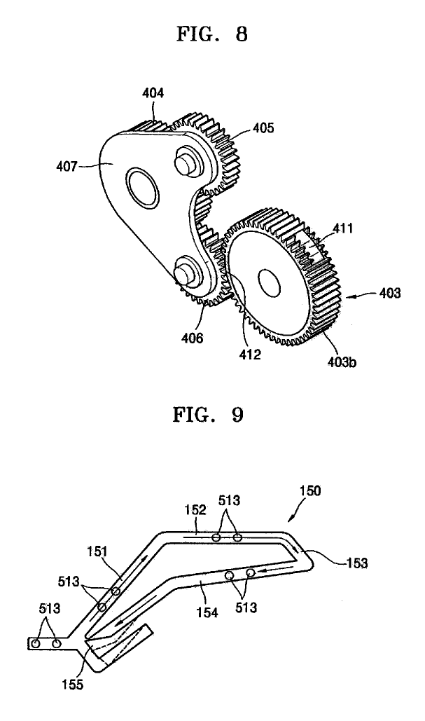

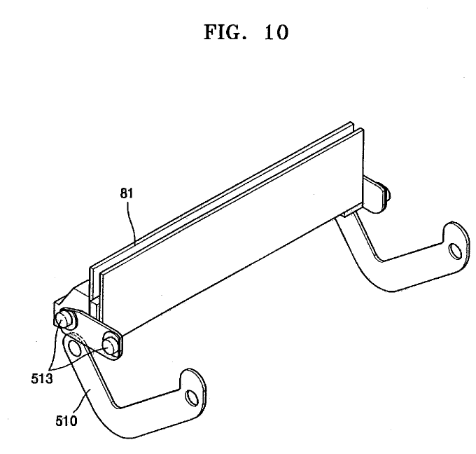

Referring to FIGS. 5, 9, and 10, a wiping locus 150 is disposed on the side walls 101 and 102. One end 511 of a first arm 510 is combined with the guide pole 62 disposed in the platen 60 so that the first arm 510 pivots about the guide pole 62. The wiper 80 is pivotably combined with the other end 512 of the first arm 510. A blade 81 or a wiping roller although not shown, can be used as the wiper 80. A cam tracking protrusion 513 disposed at the side of the wiper 80 is combined with the wiping locus 150. Referring to FIG. 9, the wiping locus 150 includes a pivot section 151 in which the wiper 80 is guided to contact the nozzle unit 11 and a sustain section 152 in which the wiper 80 is maintained in contact with the nozzle unit 11 as the platen 60 is moved to the maintenance location from the printing location. The first arm 510 guided by the pivot section 151 is pivoted in a direction in which the wiper 80 contacts the nozzle unit 11. The wiping locus 150 further includes a separated section 153 in which the wiper 80 is separated from the nozzle unit 11. The wiping locus 150 may further include a return section 154 in which the first arm 510 is guided so that the wiper 80 does not contact the nozzle unit 11 when the platen 60 is returned to the printing location from the maintenance location. An elastic arm (or elastic section) 155 serves as a latch which allows the cam tracking protrusion 513 to be moved to the pivot section 151 from the return section 154 and blocks the cam tracking protrusion 513 from moving back to the return section 154 from the pivot section 151.

Referring to FIGS. 4 and 5, a second arm 520 is installed in the guide member 70 to guide the paper P under the nozzle unit 11, to be pivoted. One end 521 of the second arm 520 is combined with a pivot axis (pivot axle) 71 disposed in the guide member 70. The cap member 90 is installed on the other end 522 of the second arm 520. A second shaft 550 is inserted into a hole 132 to be rotatably supported on the side walls 101 and 102. A d-cut part 551 is disposed on both ends of the shaft 530. A pair of third connection arms 561 is combined with the d-cut part 551 of the shaft 550 and connected to a pair of fourth connection arms 562 to be pivoted. The pair of connection arms 562 is connected to the second arm 520 to be pivoted.

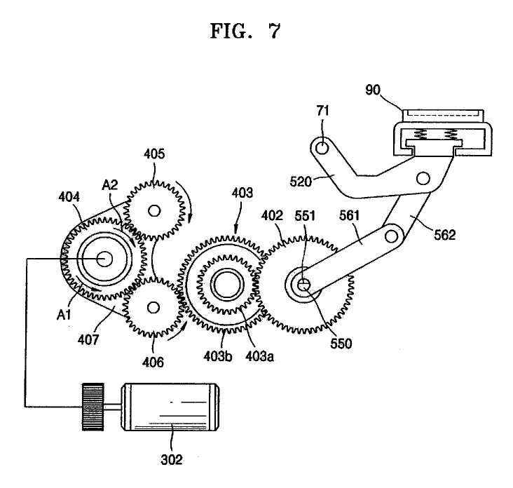

FIGS. 7 and 8 illustrate a mechanism to move the cap member 90 to a capping location and an uncapping location using the driving motor 302 driving the conveying unit 20 and the exhaust unit 30, respectively. Although not shown, the driving motor 302 is connected to the conveying unit 20 and the exhaust unit 30 using a power connection element such as a gear. While performing a capping operation, since the paper P is not picked up from the paper feeding cassette 50 even when the driving motor 302 is driven to operate the conveying unit 20 and the exhaust unit 30, the paper P is not conveyed. A second driven gear 402 is combined with the d-cut part 551 of the second shaft 550. A third driven gear 403 includes first and second gear parts 403a and 403b. The first gear part 403a comes in contact with the second driven gear 402. A pair of swing gears 405 and 406 comes in contact with a gear 404 rotated with the driving motor 302. The pair of swing gears 405 and 406 is installed at a swing arm 407. The pair of swing gears 405 and 406 selectively come in contact with a second gear part 403b of the third driven gear 403 according to a rotational direction of the gear 404.

A pair of idling parts 411 and 412 of which tooth form is omitted is disposed in the second gear part 403b of the driven gear 403. The respective idling parts 411 and 412 correspond to the uncapping location and the capping location, respectively. The respective idling parts 411 and 412 correspond to the corresponding swing gears 405 and 406, respectively. If the gear 404 is rotated in a direction A1, the swing arm 407 is rotated in the direction A1 and the swing gear 406 comes in contact with the second gear part 403b of the third driven gear 403. The cap member 90 is moved to the capping location from the uncapping location. If the cap member 90 reaches the capping location, the swing gear 406 is disposed in the idling part 412, and even though the swing gear 406 is rotated, the cap member 90 is not rotated. If the gear 404 is rotated in a direction A2, the swing arm 407 is also rotated in the direction A2 and the swing gear 405 comes in contact with the second gear part 403b of the driven gear 403. The cap member 90 is moved to the uncapping location from the capping location. If the cap member 90 reaches the uncapping location, the swing gear 405 is disposed in the idling part 411, and even though the swing gear 405 is rotated, the cap member 90 is not rotated. When the driving motor 302 rotates the gear 404 in the direction A2, the conveying unit 20 and the exhaust unit 30 may operate in a direction in which the paper P is conveyed in the sub-scanning direction S. The conveying unit 20 and the exhaust unit 30 and the cap member 90 can be driven using the driving motor 302 with the above structure.

The function of the ink-jet image forming apparatus will now be described with reference to FIGS. 4 through 13. Referring to FIG. 4, the platen 60 is disposed in the printing location and supports the rear side of the paper P. A user can input paper information including a thickness of the paper P stacked on the paper feeding cassette 50 using a user interface unit 210. Although not shown, the user interface unit 210 may be an operational panel for the ink-jet image forming apparatus or an interface program of a host computer to which the ink-jet image forming apparatus is connected. As shown in FIG. 4, the ink-jet image forming apparatus may further include a sensor 220 to sense the type of the paper P stacked on the paper feeding cassette 50. As an example, an optical sensor to detect the amount of light reflected by irradiating light onto the paper P may be used as the sensor 220. In general, reflectivity of a photo paper is higher than a plain paper. A controller 200 receives light amount information from the sensor 220 and determines whether the paper P stacked on the paper feeding cassette 50 is the plain paper or the photo paper based on the light amount information.

The controller 200 selectively disposes the platen 60 in the step parts 121 and 122 according to the thickness of the paper P stacked on and picked up from the paper feeding cassette 50, thereby maintaining an interval between the nozzle unit 11 and the upper side of the paper P.

For example, if the paper P stacked on the paper feeding cassette 50 is the plain paper, the protrusion 61 of the platen 60 is adjusted to be disposed in the step part 121. When the platen 60 is disposed in the printing location or the maintenance location, it cannot be moved in the subs-canning direction S any more. In this state, load applied in the maintenance motor 301 is increased so that a driving current is rapidly increased. The controller 200 detects the driving current supplied to the maintenance motor 301 and whereby it can be understood whether the platen 60 is disposed in the printing location or the maintenance location. The step part 121 is disposed at an end of the printing location of the cam locus 120. Thus, when the maintenance motor 301 is not rotated any more in a direction in which the platen 60 is moved in the direction S2, that is, when the driving current supplied to the maintenance motor 301 is rapidly increased while the maintenance motor 301 is rotated in the direction in which the platen 60 is moved in the direction S2, the protrusion 61 of the platen 60 is disposed in the step part 121, as illustrated in FIG. 6B.

If the paper P stacked on the paper feeding cassette 50 is the photo paper, the controller 200 rotates the maintenance motor 301 and the protrusion 61 of the platen 60 is disposed in the step part 121. Then, the controller 200 rotates the maintenance motor 301 by a predetermined amount of rotation in the direction in which the platen 60 is moved in the direction S1 so that the protrusion 61 of the platen 60 can be disposed in the step part 122, as illustrated in FIG. 6C. An interval between the step parts 121 and 122 may be converted into a driving parameter corresponding to a driving time or rotation amount of the maintenance motor 301, for example, and may be preset in the controller 200.

Although not shown, the ink-jet image forming apparatus may include a plurality of position detection sensors to correspond to locations of the step parts 121 and 122 and a maintenance location, and to detect the location of the platen 60. In this case, the controller 200 may selectively dispose the platen 60 in the step parts 121 and 122 based on information input from the position detection sensors or the a user. Besides, various methods of disposing the platen 60 in a desired location may be applied.

If the interval between the nozzle unit 11 and the upper side of the paper P is adjusted to have the same distance between the nozzle unit 11 and the upper surface of the paper P, the conveying unit 20 is driven using the driving motor 302, the paper P is conveyed along a paper conveying path 100, ink is ejected onto the paper P, and whereby an image is formed. At this time, since the swing gear 406 is disposed in the idling part 412 of the driven gear 403, the driven gear 403 is not rotated. Thus, the cap member 90 is not moved in the uncapping location. In addition, the spitting operation is performed when the paper P does not exist on the paper conveying path 100 before an image is printed or after several sheets of paper are printed. The spitted ink is dropped in the accommodating portions 66 disposed in the platen 60 to correspond to the arrangement of the nozzle plates 12. Thus, even though the paper P is conveyed after spitting, the rear side of the paper P is not contaminated since the spitted ink is accommodated in the accommodating portions 66.

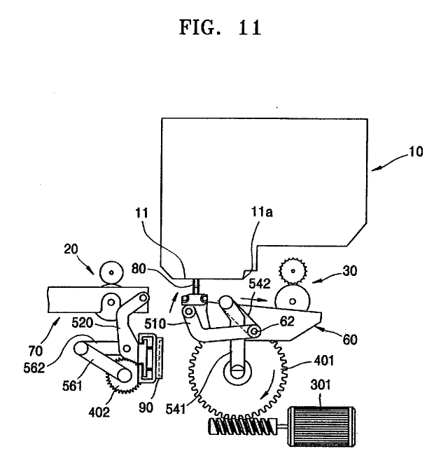

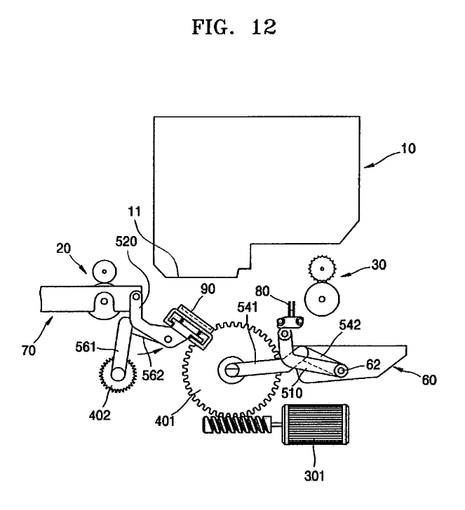

If the maintenance motor 301 rotates the first driven gear 401 for the maintenance operation, the shaft 530 is rotated. The first and second connection arms 541 and 542 are rotated. The slot 543 of the second connection arm 542 pushes the guide pole 62 a predetermined time after the second arm 542 starts to move due to a length of the slot 543. The platen 60 is guided to the cam locus 120 and is moved towards the lower part of the exhaust unit 30. The first arm 510 pivots on the guide pole 62. And the cam tracking protrusion 513 is guided by the pivot section 151 of the wiping locus 150, and as shown in FIG. 11, the wiper 80 contacts the nozzle unit 11. After the wiper 80 contacts the nozzle unit 11, the cam tracking protrusion 513 is guided by the sustaining period 152. The wiper 80 is moved to a straight line parallel to a surface of the nozzle unit 11 and wipes the nozzle unit 11 while being maintaining in the state where it contacts the nozzle unit 11. The cam tracking protrusion 513 is guided by the separated section 153. And the wiper 80 is separated from the nozzle unit 11. If the platen 60 is located in the maintenance location, as illustrated in FIG. 12, the wiper 80 completely deviates from the nozzle unit 11.

Now, the driving motor 302 is driven to perform an operation of capping the nozzle unit 11. Although the conveying unit 20 is driven, because the paper P is not picked up from the paper supply cassette 50, the paper P is not conveyed. Referring to FIG. 7, if the driving motor 302 rotates the gear 404 in direction A1, the swing gear 406 comes in contact with the second gear part 403b of the third driven gear 403. The third driven gear 403 is rotated in the direction A1, and the third and fourth connection arms 561 and 562 push the second arm 520. The second arm 520 pivots around a pivot axis 71 disposed in the guide member 70. And as illustrated in FIG. 12, the cap member 90 begins to be moved towards the nozzle unit 11. As illustrated in FIG. 13, if the cap member 90 caps the nozzle unit 11, the swing gear 406 is located in the idling part 412 of the driven gear 403. The cap member 90 is not moved although the driving motor 302 is rotated.

If the driving motor 302 rotates the gear 404 in direction A2 for an uncapping operation, the swing gear 405 comes in contact with the second gear part 403b of the driven gear 403. The driven gear 403 is rotated in the direction A2, and the connection arms 541 and 542 pull the second arm 520. The second arm 520 pivots around the pivot axis 71 disposed in the guide member 70. And the cap member 90 is separated from the nozzle unit 11. If the cap member 90 reaches the uncapping location, the swing gear 405 is located in the idling part 411 of the driven gear 403. The cap member 90 is not moved although the driving motor 302 is rotated.

The process of moving the platen 60 to the printing location from the maintenance location is processed as the reverse order of the process of moving to the maintenance location from the printing location. In the process of returning to the printing location, the wiping locus 150 includes the return section 154 so that the wiper 80 cannot contact the nozzle unit 11. As illustrated in FIGS. 5 and 9, since the elastic arm 155 is located in the return section 154, the cam tracking protrusion 513 pushes the elastic arm 155 and returns to the pivot section 151. Again, when the platen 60 is moved to the maintenance location, since the elastic arm 155 serves as a latch, the cam tracking protrusion 513 does not enter the return section 154 and is guided by the pivot section 151.

As described above, in the ink-jet image forming apparatus according to the present embodiment, since the interval between the upper side of the paper and the nozzle unit is maintained according to types of papers, good printing quality can be implemented. In addition, since the platen is moved for the maintenance operation and the interval between the upper side of the paper and the nozzle unit is adjusted using a movement of the platen, a structure of the ink-jet image forming apparatus can be simplified and components and manufacturing costs thereof can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink-jet image forming apparatus comprising:
an ink-jet head including a nozzle unit having a length in a main scanning direction corresponding to a width of a printing medium;
a platen to move to a printing location in which the platen faces the nozzle unit and supports a rear side of the printing medium for a printing operation, and to a maintenance location different from the printing location for a maintenance operation; and
a cam locus to guide the platen, and having an interval adjusting portion to control the platen to adjust an interval between the platen and the nozzle unit.

2. The ink-jet image forming apparatus of claim 1, wherein the platen moves along the cam locus in a sub-scanning direction having an angle with the main scanning direction.

3. The ink-jet image forming apparatus of claim 2, wherein the interval adjusting portion comprises a plurality of step parts separated from each other in the sub-scanning direction and stepped perpendicularly to the sub-scanning direction.

4. The ink-jet image forming apparatus of claim 3, further comprising:
a controller to adjust the interval between the platen and the nozzle unit by moving the platen in the sub-scanning direction corresponding to information on a thickness of the printing medium.

5. The ink-jet image forming apparatus of claim 4, wherein the information is input to the controller via a user interface.

6. The ink-jet image forming apparatus of claim 4, further comprising:
a sensor detect a type of the paper,
wherein the controller determines the thickness of the printing medium.

7. The ink-jet image forming apparatus of claim 6, wherein the sensor comprises an optical sensor to detect an amount of light reflected from the printing medium, and the controller determines the printing medium as at least one of a plain paper and a photo paper from the detected amount of light.

8. An ink-jet image forming apparatus comprising:
an ink-jet head having a nozzle unit; and
a platen disposed to form a paper conveying path with the nozzle unit, disposed in a printing location having a first printing location to have a first distance with the nozzle unit in the paper conveying path and a second printing location to have a second distance with the nozzle unit in the paper conveying path, and disposed a maintenance location different from the printing location where the ink-jet head is maintained.

9. The ink-jet image forming apparatus of claim 8, further comprising:
a locus unit to control a movement of the platen to the first printing location, the second printing location, and the maintenance location; and
a maintenance device connected between the platen and the locus unit to maintain the nozzle unit when the platen moves to the maintenance location.

10. The ink-jet image forming apparatus of claim 9, wherein the locus unit comprises a cam locus to control a movement of the platen and a wiping locus to control a movement of the maintenance device, and the maintenance device is connected between the wiping locus and the platen.

11. The ink-jet image forming apparatus of claim 10, wherein the cam locus comprises a first step part to dispose the platen in the first printing location, a second step part to dispose the platen in the second printing location, and an inclined part to move the platen to the maintenance location.

12. The ink-jet image forming apparatus of claim 9, wherein the maintenance device dose not move when the platen moves between the first printing location and the second printing location.

13. The ink-jet image forming apparatus of claim 9, wherein the maintenance device move to maintain the nozzle unit when the platen moves between the maintenance location and one of the first printing location and the second printing location.

14. The ink-jet image forming apparatus of claim 8, wherein the first printing location is spaced-apart from the second printing location by a distance corresponding to a thickness difference between first and second printing media dispose in the paper conveying path between the platen and the nozzle unit.

15. The ink-jet image forming apparatus of claim 8, wherein the first printing location is parallel to the second printing location in a direction perpendicular to the paper conveying path.

16. The ink-jet image forming apparatus of claim 8, further comprising:
a wiping unit disposed to maintain the nozzle unit when the platen moves to the maintenance location from the first and second printing locations; and
wherein a wiping locus controls the wiping unit to contact the ink-jet head when a cam locus controls the platen to move to the maintenance location.

17. The ink-jet image forming apparatus of claim 16, further comprising:
a maintenance motor;
a connecting arm connected between the maintenance motor and the platen;
a protrusion formed on the platen to be connected to the cam locus; and
another arm having a first end connected between the platen and a second end connected to the wiping locus.

18. A method of an ink-jet image forming apparatus, the method comprising:
disposing a platen to form a paper conveying path with the nozzle unit;
disposing the platen in a printing location having a first printing location to have a first distance with the nozzle unit in the paper conveying path and a second printing location to have a second distance with the nozzle unit in the paper conveying path; and
disposing the platen in a maintenance location different from the printing location where the ink-jet head is maintained.
